(19) United States
(12) Patent Application Publication
(10) Pub. No.: US 2012/0187036 A1
(43) Pub. Date: Jul. 26, 2012

(54) Water Filter With Inwardly Sloping Top

(76) Inventor: Tareq Risheq, Laguna Niguel, CA (US)

(21) Appl. No.: 13/358,398

(22) Filed: Jan. 25, 2012

Related U.S. Application Data
(60) Provisional application No. 61/435,906, filed on Jan. 25, 2011.

(51) Int. Cl. B01D 35/02; C02F 1/00; B01D 27/00

(52) U.S. Cl. 210/282; 210/466

(57) ABSTRACT

A filter cartridge for a water bottle is presented. The filter cartridge has a top portion with a concave exterior surface and an inlet. The top portion is removeably coupled with a bottom portion to form an enclosure for housing a filter. The bottom portion also has an inlet to allow water to pass through the filter cartridge. The filter cartridge also has an outer rim with a sealing ring.

This application claims the benefit of priority to provisional application Ser. No. 61/435,906 filed on Jan. 25, 2011, which is incorporated herein by reference.

### FIELD OF THE INVENTION

The field of the invention is water filters, and more specifically water filters for use within a water dispensing apparatus.

### BACKGROUND

Water bottles are well known in the art, and generally consist of a compressible water reservoir having a bottle neck to which a nozzle or cap is coupled. Many different water bottle designs have been developed over the years for numerous purposes. Recently, there has been a significant increase in demand for filtered water, and it is known to incorporate a filtration device within a water bottle.

For example, U.S. Pat. No. 5,609,759 to Nohren Jr. describes a water bottle having a tube of filtering material with porous side walls coupled to the cap. The tube is inserted through an open neck of the bottle. Unfortunately, Nohren's filter tube must be very long and/or contain very little filter material in order to pass through the opening of the water bottle.

U.S. Publication No. 2007/0221570 to Aregger teaches a water filter that includes a flat top cover having water inlets and a bottom portion with an outlet. The cover and bottom houses several spiral channels for holding a filter material and channeling the water through the filter material. One problem with Aregger's design is that the design of the cover does not allow excess liquid to flow back though filter, which can cause leaking.

Nohren and Aregger and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for improved water bottle-filter configurations.

### SUMMARY OF THE INVENTION

The inventive subject matter provides apparatus, systems and methods in which a filter cartridge house a filter and couples with a bottle opening. The filter cartridge has a top portion with a concave exterior surface. The top portion mates with a bottom portion to form an enclosure large enough to house a filter. The top and bottom portions each have at least one opening for allowing a liquid to flow through the cartridge.

In one aspect of some embodiments, the top portion further includes a rim and a sealing ring disposed within the rim. In another aspect of some embodiments, the top portion couples to the bottom portion by a snap fitting. In yet other aspects, the bottom portion includes inner and outer concentric walls that form a cavity sized and dimensioned to house the filter.

In some embodiments the filter is concave and securely attached to an inner surface of the filter cartridge. The filter can be a replaceable cartridge configured to removeably couple to an inside portion of the filter cartridge. In yet other embodiments, the filter comprises an activated carbon, high reactivity carbon mixture (HCRM), and/or an iodinated resin. In some embodiments the filter is molded and has a cylindrical shape. The filter is preferably capable of reducing contaminants in the liquid by at least 99%. In other embodiments, the filter comprises a mesh fabric capable of filtering bacteria, giardia and/or microbial cysts.

In one aspect of some embodiments, the filter cartridge also includes an air value for equalizing air pressure.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a cross section view of one embodiment of a filter cartridge for a water bottle.

FIG. 2 is a cross section view of another embodiment of a filter cartridge.

FIG. 3 is a perspective view of the filter cartridge in FIG. 2.

FIG. 4 is an exploded view of a water bottle and a filter cartridge.

FIG. 5a is a bottom-perspective view of the filter cartridge in FIG. 4.

FIG. 5b is a top-perspective view of the filter cartridge in FIG. 4.

FIGS. 5c-f are various views of the concave exterior surface of the top portion of the filter cartridge in FIG. 4.

FIGS. 6a-e are various views of a filter cartridge that has a concave exterior surface.

FIG. 7a is a side view of a water bottle with a cap.

FIG. 7b is a cross section view of the water bottle in FIG. 7a.

FIG. 7c is a close-up of FIG. 7b.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

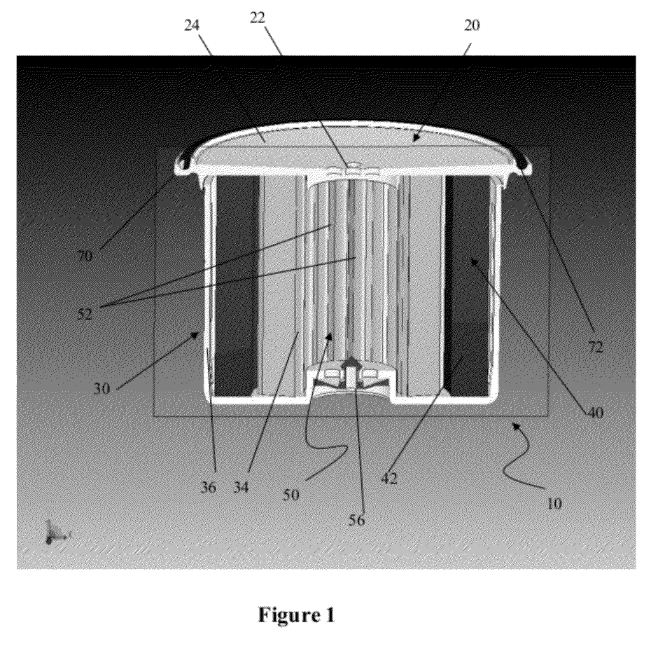

FIG. 1 shows a filter cartridge 10. Cartridge 10 includes a top portion 20 having openings 22 for dispensing/draining a liquid, and a bottom portion 30 having inlets 52 to allow for liquid to flow through filter 42. Cartridge 10 is designed to couple to a bottle.

It is contemplated that top portion 20 and bottom portion 30 can be mechanically coupled together via a snap fitting, a quick release mechanism, magnetic, or any other suitable means known in the art that are capable of coupling top portion 20 with bottom portion 30.

Cartridge 10 has a rim 70. Rim 70 aids in either the coupling the top portion 20 with the bottom portion 30 or for seating/coupling cartridge 10 to a bottle top or reservoir. Rim 70 includes a sealing ring 72 disposed within the ring to aid in leakage prevention.

As shown in FIG. 1, top portion 20 has an exterior surface 24 that permits excess liquid to drain back through filter 42 via openings 22 when cartridge 10 is not in use. Bottom portion 30 includes inner and outer concentric walls 34 and 36 that form a filter holding portion 40 and an inner depression 50 having one or more inlets 52. Bottom portion 30 includes air vent 56 and additional inlets on the exterior surface.

Filter cartridge 10 can be constructed out of polyethylene, polypropylene, polyvinyl chloride, polyethylene terepthalate, or any other suitable natural and synthetic polymer. Filter cartridge 10 is sized and dimensioned to house filter 40.

Filter 40 is preferably constructed out of at least one of high reactivity carbon mixture (HCRM), activated carbon, and iodinated resin, or any other suitable compositions for filtering water, or combinations thereof. High Reactivity Carbon Mixture (HRCM) is manufactured by a unique method of cold autocatalytic decomposition of graphite (See Appendix 1). HRCM has an extremely large specific surface area (2,500 m2 per 1 gram of HRCM). The surface of this material consists of atomic layers of cyclic carbon (graphenes) with damaged molecular bonds. HRCM is a chemically inert substance, electro conductive, hydrophobic, stable in corrosive environments and ecologically clean. HRCM consists of 99.4% pure carbon materials with a bulk density of 0.01-0.001 g/cm3 (depending on the manufacturing method). Filter 40 can have a pore size of at least 0.2 to 100 microns, preferably 1 to 25 microns.

It is also contemplated that filter 40 can further comprise a woven or non-woven mesh fabric to aid in the filtration of viruses, bacteria, giardia, microbial cysts and other submicron particles. For example, such as a nonwoven mesh composed of nano-fibers, such as AHLSTROM DISRUPTOR® Nonwoven Filter Media, which has nano-fibers that are 2 nm in diameter and 250 nm in length, and thus have a surface area of >500 gsm, and which create a natural positive charge that aids in the absorption of the contaminant.

In preferred embodiments, filter 40 can be molded into a cone, concave, or frustoconical shape, but it is also contemplated that filter 40 could be molded into a flat disc, or any other size and shape. It is also contemplated that filter 40 could be in a granular form and contained within a mesh bag or other holding cartridge.

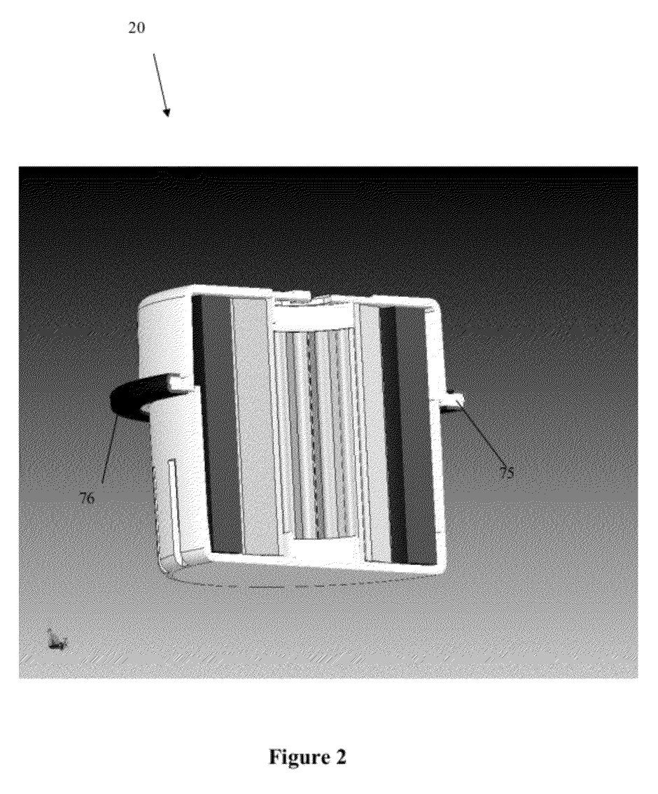

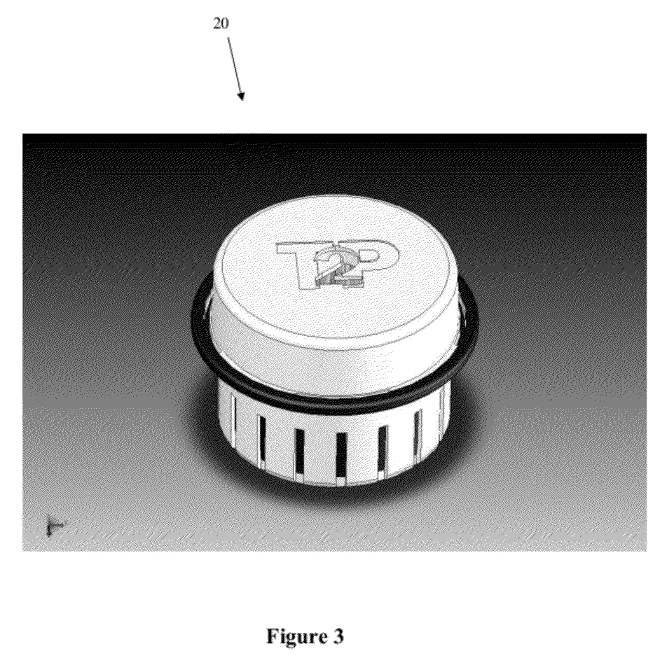

FIG. 2 shows a cross section view of a filter cartridge 20. FIG. 3 shows a perspective view of cartridge 20. Cartridge 20 is similar to cartridge 10 excpet that cartridge 20 has a rim 75 and seal 76 that is located at a lower position than rim 70 and seal 72 of cartridge 10. The location and size of the rim and seal can vary, depending on the particular application (e.g., size of bottle opening).

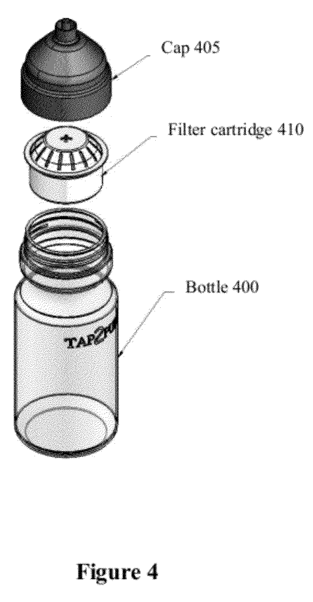

FIG. 4 depicts a bottle 400 having cap 405 and a filter cartridge 410. Cartridge 410 has a cylindrical shape, however, any size and shape suitable for coupling with a bottle opening or bottle reservoir are contemplated. The top portion of cartridge 410 is depicted as having openings (e.g., inlets) to allow liquid to freely flow through the filter housed within cartridge 410. Cartridge 410 has a rim that couples with the outer diameter of the opening of bottle 400. Cartridge 410 securely fits inside cap 405 and bottle 400.

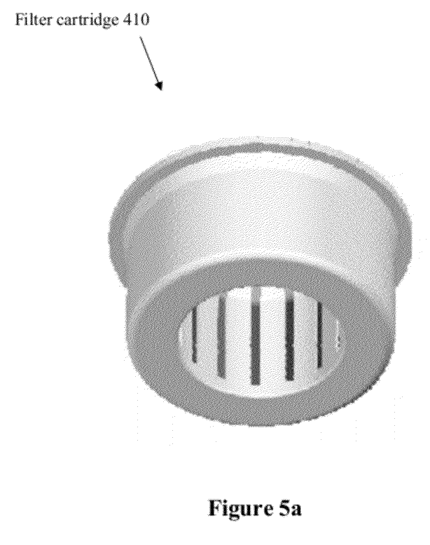

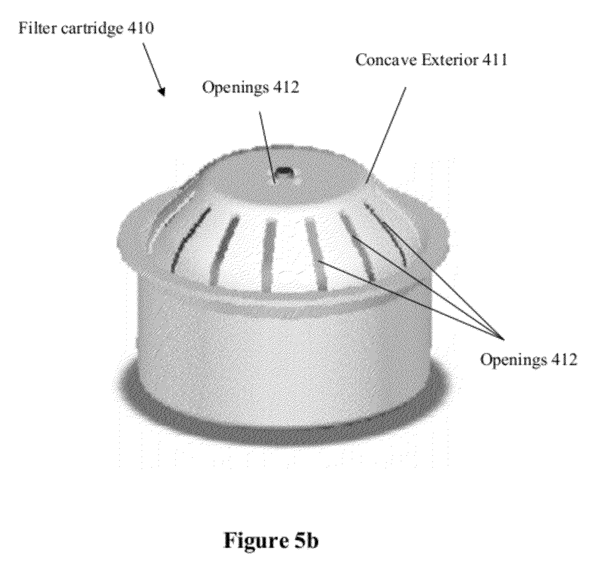

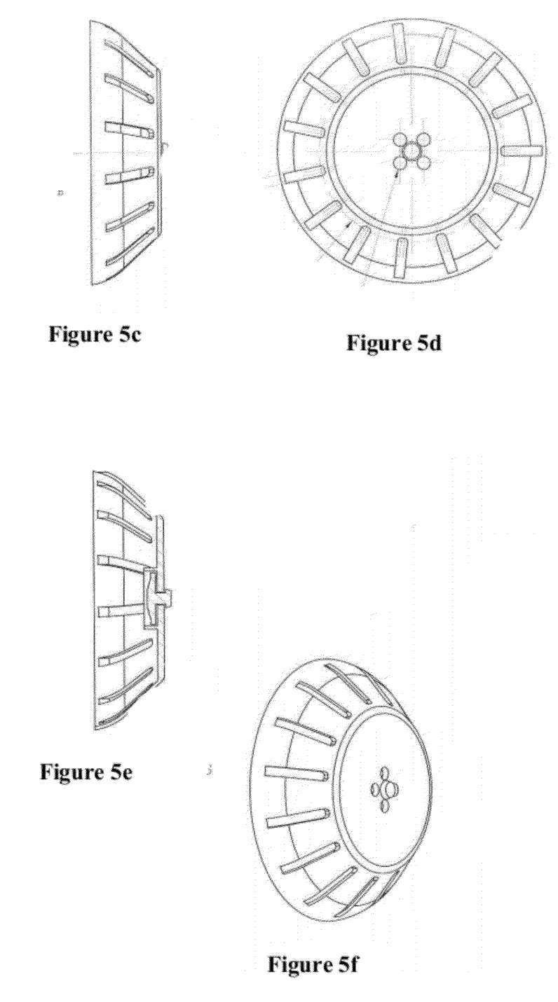

FIGS. 5a shows a bottom perspective view of cartridge 410. FIG. 5b shows a top perspective view of cartridge 410. Cartridge 410 has a concave exterior surface 411 with openings 412. When cartridge 410 is inside bottle 400 and cap 405, and bottle 400 is not in use (i.e., bottle 400 is in an upright position), surface 411 helps water to drain back into bottle 400 via openings 412. Surface 411 conforms to the interior contours of cap 405, allowing cartridge 410 to securely couple with cap 405 and bottle 400. FIG. 5c-f show various views of the surface 411.

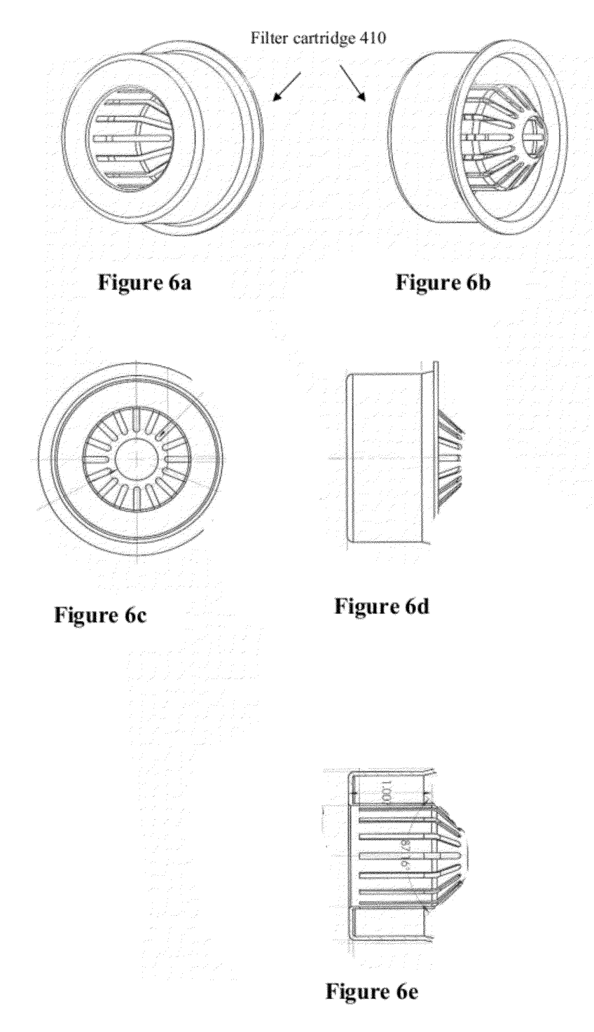

FIGS. 6a-e show various views of a filter cartridge 610. Cartridge 610 has a slightly different shape and contour than cartridge 410. For example, cartridge 610 has a concave exterior surface surrounding by an elevated rim. Those of skill in the art will appreciate that many different shapes and contours can be used consistently with the inventive subject matter disclosed herein.

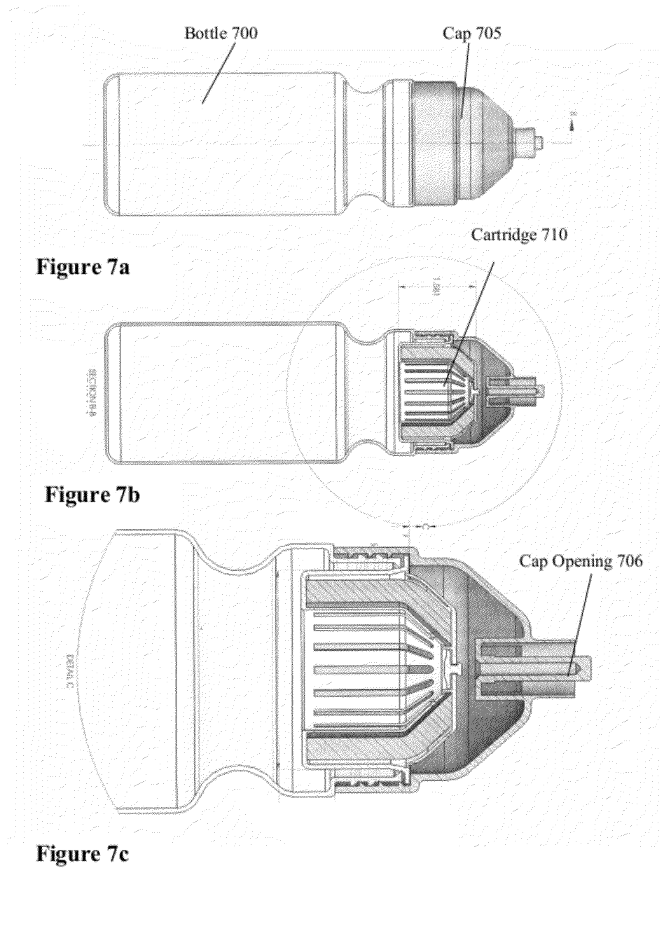

FIG. 7a shows a side view of a water bottle 700 and cap 705. FIG. 7b shows a cross section view of the bottle 700 and cap 705, exposing a filter cartridge 710. Cartridge 710 fits snugly and securely within bottle 700 and cap 705. Cartridge 710 is configures such that water contained in bottle 700 must pass through cartridge 710 before exiting cap opening 706 (see FIG. 7c).

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filter cartridge for house a filter, comprising:
a top portion having a concave exterior surface and a first opening;
a bottom portion coupled to the top portion and having a second opening;
wherein the top and bottom portions mate with each other to form an enclosure sized and dimensioned to house the filter; and
wherein the filter cartridge is configured to couple to a bottle opening.

2. The filter cartridge of claim 1, wherein top portion further comprises a rim having a sealing ring disposed within the rim.

3. The filter cartridge of claim 1, wherein top portion couples to the bottom portion by a snap fitting.

4. The filter cartridge of claim 1, wherein the bottom portion includes inner and outer concentric walls that form a cavity sized and dimensioned to house the filter.

5. The filter cartridge of claim 1, wherein the filter is concave and securely attached to an inner surface of the filter cartridge.

6. The filter cartridge of claim 1, wherein the filter is a replaceable cartridge configured to removeably couple to an inside portion of the filter cartridge.

7. The filter cartridge of claim 1, wherein the filter further comprises at least one of activated carbon, high reactivity carbon mixture (HCRM), and iodinated resin.

8. The filter cartridge of claim 1, wherein the filter is molded and has a cylindrical shape.

9. The filter cartridge of claim 1, wherein the filter is capable of reducing contaminants in the liquid by at least 99%.

10. The filter cartridge of claim 1, wherein the filter further comprises a mesh fabric capable of filtering out at least one of bacteria, giardia and microbial cysts.

11. The filter cartridge of claim 1, wherein the filter cartridge includes an air value for equalizing air pressure.
